(19) United States
(12) Patent Application Publication
(10) Pub. No.: US 2025/0373329 A1
(43) Pub. Date: Dec. 4, 2025

(54) METHODS AND SYSTEMS FOR IDENTIFYING ONE OR MORE COMMON OPTICAL PATH PORTIONS BETWEEN DEPLOYED OPTICAL FIBERS

(71) Applicant: EXFO INC., Quebec (CA)

(72) Inventors: Michel LECLERC, Quebec (CA); Olivier PLOMTEUX, Quebec (CA); Louis BELANGER SANSOUCY, Quebec (CA)

(21) Appl. No.: 19/065,506

(22) Filed: Feb. 27, 2025

Related U.S. Application Data
(60) Provisional application No. 63/654,385, filed on May 31, 2024.

(51) Int. Cl. H04B 10/071; G01D 5/353; G01H 9/00

(52) U.S. Cl. CPC H04B 10/071; G01D 5/35358; G01H 9/004

(57) ABSTRACT

Methods and systems for identifying one or more common optical path portions between a first and a second deployed optical fibers of a communication network are disclosed. Each of the first and second deployed optical fibers are potentially affected by vibration events therealong. A method includes performing a plurality of successive acquisitions, each acquisition comprising sending at least one test signal sensitive to the vibration events in the first and second deployed optical fibers and receiving at least one return test signal therefrom, locating the vibration events affecting the first and second deployed optical fibers based on the received at least one return test signal over said plurality of acquisitions, determining a correspondence between the vibration events located along the first and the second deployed optical fiber, respectively and identifying the one or more common optical path portions between the first and second optical fibers based on said correspondence.

### TECHNICAL FIELD

The technical field generally relates to optical fiber testing, and more particularly to identification of common optical path portions between deployed optical fibers.

### BACKGROUND

In order to meet the rising demand for international communications, extensive installations of optical communications infrastructure, such as optical fibers, have been deployed or are in the process of being deployed. Furthermore, it is known that these communications facilities can be installed inside buildings or other structures, underground (e.g. in conduits), or aerially (e.g. on dedicated poles).

However, optical fiber management can be a challenging task in a variety of contexts. Indeed, fiber-based communication networks typically include a large number of optical fibers which may be deployed over numerous routes in such a way that precisely tracking those routes and/or determining whether two deployed optical fibers are hosted in a same communication cable can be a cumbersome operation. In addition, accuracy of an optical cable installation location may be subject to substantial error for some facilities. Consequently, it may be complex to determine whether two given optical fibers are located in a same fiber cable, which may be, for example, a meaningful indication of a redundancy and/or a diversity of the communication network.

Therefore, systems and methods for identification of common optical path portions between deployed optical fibers that can alleviate at least some of these drawbacks may be desirable.

### SUMMARY

In accordance with one aspect, there is provided a method for identifying one or more common optical path portions between a first and a second deployed optical fibers of a communication network, each of the first and second deployed optical fibers being potentially affected by vibration events therealong. The method includes performing a plurality of successive acquisitions, each acquisition comprising sending at least one test signal sensitive to the vibration events in the first and second deployed optical fibers and receiving at least one return test signal therefrom, locating the vibration events affecting the first and second deployed optical fibers based on the received at least one return test signal over said plurality of acquisitions, determining a correspondence between the vibration events located along the first and the second deployed optical fiber, respectively and identifying the one or more common optical path portions between the first and second optical fibers based on said correspondence.

In some implementations, sending the at least one test signal and receiving the at least one return signal comprises employing at least one Distributed Acoustic Sensing-Optical Time-Domain reflectometer (DAS-OTDR).

In some implementations, sending at least one test signal in the first and second deployed optical fibers and receiving at least one return test signal includes sending a first test signal in the first deployed optical fiber and receiving a first return test signal therefrom and sending a second test signal in the second deployed optical fiber and receiving a second return test signal therefrom.

In some implementations, the at least one DAS-OTDR comprises a first and a second DAS-OTDR, and sending the first test signal and receiving the first return test signal includes employing the first DAS-OTDR, and sending the second test signal and receiving the second return test signal includes employing the second DAS-OTDR, the first and second test signals being sent in a simultaneous manner.

In some implementations, the at least one DAS-OTDR includes a main DAS-OTDR, and sending the first and the second test signals and receiving the corresponding first and second return test signals includes employing the main DAS-OTDR, the first and second test signals being sent in a consecutive manner.

In some implementations, determining a correspondence between the vibration events located along the first and the second deployed optical fibers includes determining an overlap between the vibration events located in the first and second deployed optical fibers.

In some implementations, determining a correspondence between the vibration events located along the first and the second deployed optical fibers includes building first and second waterfall plots representing a measured vibration intensity as a function of time and of a distance along the first and the second deployed optical fibers, based on the first and second return test signal, respectively and comparing the first and second waterfall plots.

In some implementations, comparing the first and second waterfall plots includes determining correlation values between the first and second waterfall plots at corresponding distance values, the correspondence being based on said correlation values.

In some implementations, comparing the first and second waterfall plots comprises binarizing the first and second waterfall plots using a pre-determined intensity threshold and, for each slice of a plurality of distance slices of range Δz along the binarized first and second waterfall plots, identifying and counting a number of said vibration events at substantially same times and at same positions on the binarized first and second waterfall plots, and dividing the number of said vibration events by a total sum of said vibrations events from both of the first and second binarized waterfall plots.

In some implementations, the method further includes employing a pre-trained machine learning model (MLM) configured to identify and denoise weak signals in the first and second waterfall plots.

In some implementations, the at least one DAS-OTDR includes a main DAS-OTDR and the first and second deployed optical fibers each have a proximal end and a distal end, the distal ends being optically connected together and sending at least one test signal in the first and second deployed optical fibers and receiving at least one return test signal includes sending a single test signal and receiving a single return test signal employing the main DAS-OTDR connected to the proximal end of the first deployed optical fiber, the single test signal propagating successively in the first and second deployed optical fibers.

In some implementations, determining a correspondence between the vibration events located along the first and the second deployed optical fibers includes building a global waterfall plot representing a measured vibration intensity as a function of time and distance along the first and second deployed optical fibers, based on the single return test signal, splitting the global waterfall plot into first and second waterfall plots associated with the first and the second deployed optical fibers, respectively, inverting the second waterfall plot and comparing the first and second waterfall plots.

In some implementations, determining a correspondence between the vibration events is executed in response to locating a number of said vibration events in the first and second deployed optical fibers above respective number thresholds.

In some implementations, the method further includes, concurrently to sending the at least one test signal, artificially generating, by a vibration generating unit, at least one of the vibration events on a ground surface located in a vicinity of at least one of the first and second deployed optical fibers.

In some implementations, the method further includes determining a path diversity score for the first deployed optical fiber based on a length of the one or more common optical path portions and a total length of the first deployed optical fiber.

In accordance with another aspect, there is provided a method for determining a path diversity score of a communication network, the communication network including a plurality of deployed optical fibers potentially affected by vibration events therealong. The method includes, for each deployed optical fiber of a given subset of said plurality of deployed optical fibers, performing at plurality of successive acquisitions, each acquisition comprising sending at least one test signal sensitive to the vibration events in the deployed optical fibers of the given subset and receiving at least one return test signal therefrom, locating the vibration events affecting the deployed optical fibers of the given subset based on the received at least one return test signal over said plurality of acquisitions, determining a correspondence between the vibration events located along the deployed optical fibers of the given subset, identifying the one or more common optical path portions between deployed optical fibers of the given subset based on said correlation and determining a path diversity score for said subset of deployed optical fibers based on a length of the one or more common optical path portions, and total lengths of the deployed optical fibers of the given subset.

In accordance with yet another aspect, there is provided a system for identifying one or more common optical path portions between a first and a second deployed optical fibers of a communication network, each of the first and second deployed optical fibers being potentially affected by vibration events therealong. The system includes an interrogating unit communicably connected to at least one of the first and second deployed optical fibers and configured to perform a plurality of successive acquisitions, each acquisition comprising sending at least one test signal sensitive to the vibration events in the first and second deployed optical fibers and receiving at least one return test signal therefrom. The system also includes a controller communicably connected to the interrogating unit and configured to locate the vibration events affecting the first and second deployed optical fiber based on the received at least one return test signal over said plurality of acquisitions, determine a correspondence between the vibration events located along the first and the second deployed optical fiber, respectively and identify the one or more common optical path portions between the first and second optical fibers based on said correspondence.

In some implementations, the interrogating unit includes at least one Distributed Acoustic Sensing-Optical Time-Domain Reflectometer (DAS-OTDR).

In some implementations, the at least one DAS-OTDR comprises a first and a second DAS-OTDR, the first DAS-OTDR being configured to send a first test signal in the first deployed optical fiber and receive a first return test signal therefrom and the second DAS-OTDR being configured to send a second test signal in the second deployed optical fiber and receive a second return test signal therefrom, the controller controlling the first and second DAS-OTDR to send the first and second test signals in a simultaneous manner.

In some implementations, the at least one DAS-OTDR includes a main DAS-OTDR configured to sent, in a consecutive manner, a first and a second test signals in the first and second deployed optical fibers, respectively, and receive therefrom corresponding first and second return test signals.

In some implementations, the controller is configured so that determining a correspondence between the vibration events located along the first and the second deployed optical fibers includes building first and second waterfall plots representing a measured vibration intensity as a function of time and of a distance along the first and the second deployed optical fibers, based on the first and second return test signal, respectively and comparing the first and second waterfall plots.

In some implementations, determining a correspondence between the vibration events is executed in response to a number of the first vibration events and a number of second vibration events being above respective number thresholds.

In some implementations, the controller is further configured to determine a path diversity score for the first deployed optical fiber based on a length of the one or more common optical path portions, and a total length of the first deployed optical fiber.

Other features and advantages will be better understood upon of reading of detailed implementations with reference to the appended drawings.

### BRIEF DESCRIPTION OF THE DRAWINGS

The features and advantages of the present disclosure will become apparent from the following detailed description, taken in combination with the appended drawings, in which:

FIG. 1 is a schematic representation of a system for determining common optical path portions between deployed optical fibers in accordance with non-limiting implementations of the present technology;

FIG. 2 is a block diagram of a controller in accordance with non-limiting implementations of the present technology;

FIG. 3 is a schematic representation of the system of FIG. 1 in collaboration with a vibration generating unit in accordance with non-limiting implementations of the present technology;

FIG. 4 is a waterfall plot representative of vibration events occurring along a deployed optical fiber;

FIG. 5 is a schematic representation of the system of FIG. 1 for determining common optical path portions between deployed optical fibers in accordance with some other non-limiting implementations of the present technology;

FIG. 6 is a schematic representation of the system of FIG. 1 for determining common optical path portions between deployed optical fibers in accordance with yet some other non-limiting implementations of the present technology;

FIG. 7 illustrates a process of a global waterfall plot generated based on the implementation of the system as depicted on FIG. 6;

FIG. 8 is a block diagram of modules executed by a controller of the system of FIG. 1 in accordance with some other non-limiting implementations of the present technology;

FIGS. 9A and 9B are representations of a first and a second experimental waterfall plots respectively indicative of vibration events occurring along a respective first and second deployed optical fibers;

FIG. 10 is a graph representative of illustrative correlation values obtained from two illustrative waterfall plots;

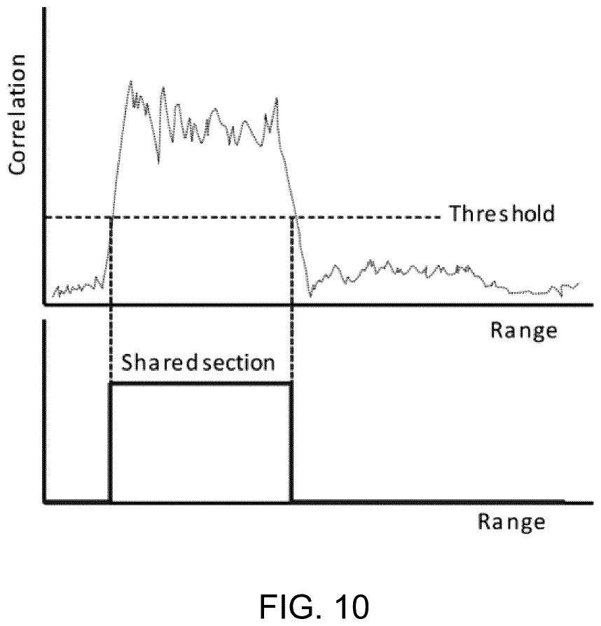

FIG. 11 illustrates the correlation values between two waterfall plots and a corresponding map of optical path portions;

FIG. 12 illustrates a binarization of waterfall plots in accordance with some non-limiting implementations of the present technology;

FIG. 13 illustrates patterns identified by machine learning models (MLM) in illustrative waterfall plots;

FIG. 14 illustrates a network of interrogating units in accordance with some non-limiting implementations of the present technology;

FIG. 15 is a flow diagram showing operations of a method for identifying one or more common optical path portions between a first and a second deployed optical fibers of a communication network in accordance with some non-limiting implementations of the present technology; and

FIG. 16 is a representation of a common optical path portion between a first and a second deployed optical fibers.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims. It should also be noted that, unless otherwise explicitly specified herein, the drawings are not to scale.

### DETAILED DESCRIPTION

Various representative implementations of the described technology will be described more fully hereinafter with reference to the accompanying drawings, in which representative implementations are shown. The present technology concept may, however, be implemented in many different forms and should not be construed as limited to the representative implementations set forth herein. Rather, these representative implementations are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

It will be understood that, although the terms first, second, third, etc. may be used herein to describe various elements, these elements should not be limited by these terms. These terms are used to distinguish one element from another, without necessarily imparting a preferred order or sequence to these elements. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represents conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “controller”, “processor” or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present disclosure.

In one aspect, the present technology provides a method for identifying one or more common optical path portions between a first and a second deployed optical fiber of a communication network.

In the context of the present disclosure, a deployed optical fiber may be understood as an optical fiber installed within an infrastructure and that may be used to carry optical signals as part of the communication network. The infrastructure may for example be a road section, a pavement, a field or any ground surface, a building, a private house or any structure suitable for integrating an optical fiber. The communication network may be embodied by a portion of an optical fiber telecommunication network such as a long-distance network, a Passive Optical Network (PON) or a Local Area Network (LAN).

In some implementations, deployed optical fibers may extend within communication cables, also referred to in the art as optical-fiber cables or fiber-optic cables. Typically, a communication cable is an assembly containing a plurality of optical fibers bundled together and surrounded by a protective tube. For reliability reasons, it is usually preferable for communication between two endpoints of a communication network to be provided along different optical paths ideally passing through different communication cables, a concept known in the art as route diversity.

In accordance with one aspect, the present technology provides a method for determining whether two or more deployed optical fibers are located inside a same communication cable, or more generally, if the optical paths defined by two or more deployed optical fibers have one or more common portions. In the context of the present disclosure, a common portion between the optical paths of two or more deployed optical fibers may be understood as segments of these optical fibers which extend alongside each other within a same communication cable, or which otherwise extends close enough to each other that they will be similarly affected by factors interfering with the reliability of the communication.

In typical communication networks, the deployed optical fibers are potentially affected by vibration events therealong. For example, different sources of vibrations such as road traffic, cars, trucks, and trains may affect a deployed optical fiber located nearby. A given optical fiber may also be deployed in submarine communication cables, circumstances in which a source of vibrations may be for example and without limitation, marine animals (e.g. whales), marine systems and equipment (e.g. boat engines), natural marine phenomenon (e.g. submarine earthquakes).

A vibration event may be understood as any instance where such vibrations from external sources reach a deployed optical fiber and impart a corresponding vibration movement on this optical fiber. As deployed optical fibers located inside a same communication cable are exposed to the same vibration sources along the communication cable's path and are thus experiencing the same vibration events, implementations of the present method advantageously make use of test signals sensitive to the vibration events to evaluate route diversity, as explained further below.

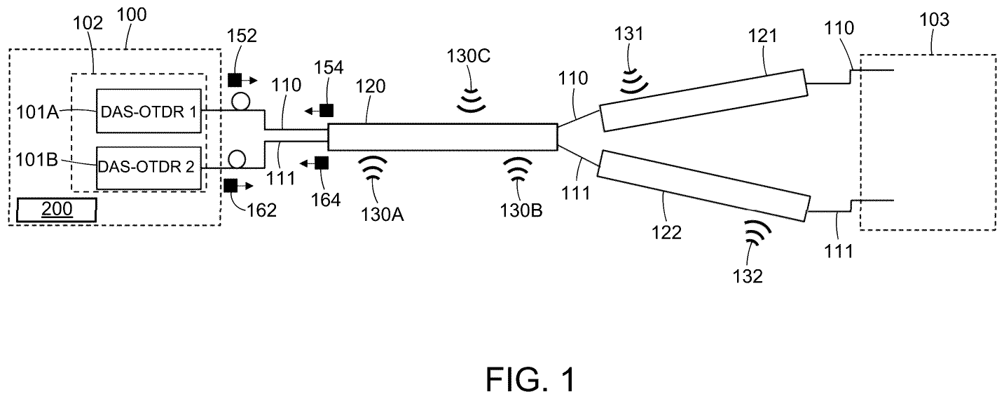

Referring to FIG. 1, there is shown an example of a system 100 suitable for executing of the aforementioned method in accordance with some non-limiting implementations of the present technology. Generally speaking, the system 100 is configured to identify common optical path portions between two given deployed optical fibers. As such, any system variation configured to enable identification of common optical path portions between deployed optical fibers in a communication network or assess a route diversity of a deployed optical fiber can be adapted to execute implementations of the present technology, once teachings presented herein are appreciated.

In some implementations, the system 100 includes an interrogating unit 102 communicably connected to the first and second deployed optical fibers 110, 111. By way of example, in FIG. 1, the first and second deployed optical fibers 110, 111 have a common optical path portion extending along a same communication cable 120. The first and second deployed optical fibers 110, 111 are further hosted by two different communication cables 121, 122 respectively and reach a landing site 103. The landing site 103 may be, for example and without limitations, an electric cabinet including server racks or any other suitable landing point for optical fibers. Of course, this configuration is shown for illustrative purposes only and is not meant to limit the scope of protection to similar configurations.

In the illustrative example, vibration events 130A, 130B, 130C affect the common optical path portion of the first and second deployed optical fibers 110, 111 located within the communication cable 120, vibration event 131 affects the first deployed optical fiber 110 located within the communication cable 121 and vibration event 132 affects the second deployed optical fiber 111 located within the communication cable 122. It should be noted that an occurrence of a vibration event may be limited in time and have a varying intensity through time.

In use, the interrogating unit 102 performs at plurality of successive acquisitions, each acquisition comprising sending at least one test signal sensitive to the vibration events in the first and second deployed optical fibers and receiving at least one return test signal therefrom.

In some implementations, the interrogating unit 102 may rely on Distributed Acoustic Sensing-Optical Time-Domain Reflectometry (DAS-OTDR—also used to refer to the corresponding device).

DAS is a technology that enables continuous, real-time measurements along the length of a fiber optic cable to provide distributed vibration sensing. For example, DAS technology may be used in the art to detect intrusion in security perimeter monitoring, to monitor highway traffic, monitor pipelines, etc.

For example, Rayleigh scatter-based DAS uses a Coherent OTDR (C-OTDR) where a coherent laser pulse is sent along the optical fiber. The interfered signals of any two or more reflected coherent lights are measured as a function of time after transmission of the laser pulse. Changes in the reflected interfered signals of successive pulses reflected from a same section of fiber are indicative of a disturbance along that section.

DAS-OTDR will be understood as a variant of OTDR based on a laser source that is substantially coherent and capable of performing vibration measurement along optical fibers.

Each DAS-OTDR acquisition is understood to refer to the actions of propagating a test signal comprising one or more test light pulses having the same pulse width in each deployed optical fiber, and detecting corresponding return light signals from the deployed optical fibers as a function of time. A test light-pulse signal travelling along an optical fiber link will return towards its point of origin either through (distributed) backscattering or (localized) reflections. The acquired power level of the return light signal as a function of time is referred to as the DAS-OTDR trace, where the time scale is representative of distance between the DAS-OTDR acquisition device and a point along the optical fiber link.

DAS-OTDR traces are acquired with a coherent laser source and either without any averaging, so to obtain a maximum vibration frequency response, or with some minimal averaging, for gaining more dynamics so to reduce vibration response frequency. The process of launching a test signal and acquiring the return light signal to obtain therefrom a DAS-OTDR trace is referred to as an “DAS-OTDR acquisition” or “acquisition”. DAS-OTDR traces are then processed to obtain a DAS signal representative of vibration and/or acoustic signal intensities.

DAS-OTDR may be specifically used for detecting vibrations and/or acoustic signals in real time, as will be described in greater detail herein after. In the following description, techniques that are generally known to the ones skilled in the art of DAS-OTDR measurement and DAS-OTDR trace processing and analysis will not be explained or detailed and in this respect, the reader is referred to available literature in the art. Such techniques that are considered to be known may include, e.g., signal processing methods for analyzing DAS-OTDR traces to obtain a DAS signal representative of vibrations and/or acoustic signals. Similarly, a DAS-OTDR acquisition device is understood to comprise conventional optical hardware and electronics as known in the art for performing DAS-OTDR acquisitions on an optical fiber link.

In some implementations, the communication network may be built with one or more out-of-band monitoring channels for dedicated transmission of the at least one test signal. The interrogating unit 102 may select an out-of-band wavelength and include a filter used to connect to a network Wavelength Division Multiplexing (WDM) tap, allowing the out-of-band wavelength to be used to measure vibrations as will be described in greater detail herein after. In some alternative implementations, the at least one test signal is transmitted over a specific DWDM channel that can be used as a dedicated sensing channel as the communication network is not built with specific monitoring channels. In this case, a wavelength used by the interrogating unit 102 matches the selected monitoring channel. Additionally, a filter may be added to the interrogating unit 102 to suppress the live traffic signals.

In the illustrative implementation of FIG. 1, the interrogating unit 102 includes a first DAS-OTDR device 101A sending, for each acquisition, a first test signal 152 through the first deployed optical fiber 110 and to receive a first return test signal 154 therefrom. The DAS-OTDR device 101A may rely on different measurement techniques to analyze the backscattered light of the first return test signal 154. In some implementations, the DAS-OTDR device 101A may be an intensity-based DAS-OTDR, which relies on the intensity (i.e. amplitude) of the first return test signal 154 as a function of time. Therefore, the vibration events affecting the first deployed optical fiber 110 may be located by comparing, at given moments in time, respective intensities of the first test signal 152 and the first return test signal 154. Alternative implementations of the step of performing the plurality of acquisitions are described herein after.

For example, the first test signal 152 may include a series of light pulses with a same or different intensities, and the intensity of the first return test signal 154 may be analyzed by the DAS-OTDR device 101A. It should be noted that in some cases, the backscattered light intensity decreases as a function of distance due to attenuation and scattering losses. An intensity-based DAS-OTDR may generate a trace that highlights the attenuation profile, locations of splices, faults, and other anomalies of the deployed optical fiber. In some embodiments of the present disclosure, a DAS-OTDR device may be implemented as described in “Fundamentals of Optical Fiber Sensing Schemes Based on Coherent Optical Time Domain Reflectometry: Signal Model Under Static Fiber Conditions” by L. B. Liokumovich et al, published in September 2015, an entirety of the content thereof being incorporated by reference.

Alternatively, the DAS-OTDR device 101A may rely on different measurement techniques to locate the vibration events along the deployed optical fiber 101A. For example, the DAS-OTDR device 101A may be a phase-based DAS-OTDR configured to measure a phase shift of the first return test signal 154.

In some implementations, the use of DAS-OTDR devices such as the DAS-OTDR device 101A permits single-ended measurements that allow measurements to be undertaken with only one field technician, thereby reducing the expense associated with additional testing personnel. Typically, a DAS-OTDR device may provide total loss, length and return loss of an optical fiber, as well as localize loss and reflectance at each joint (splice or connector). In order to characterize the input and output connectors of an optical fiber, it is usual to add a proper lead-in (“launch”) fiber and a termination fiber (sometimes referred to as a “receive” fiber) in order to provide a reference backscattering level before and after each connector.

Performing a measurement with a DAS-OTDR device may require the user to specify settings such as pulse characteristics, acquisition range (i.e. the distance light travels within the fiber) and averaging time. A single acquisition is usually performed under the selected user settings. Alternatively, a plurality of sub-acquisitions may be performed by the DAS-OTDR device within the specified acquisition time, all under the same user settings and therefore using the same pulse width, but with different gain settings, receiver bandwidth or pulse power for example. Acquired data from each sub-acquisition is then stitched together, according to their respective noise floor and saturation levels, to build a single graphical x-y representation of the backscattered light referred to as the DAS-OTDR trace.

In the context of the present disclosure, the DAS-OTDR device, or Distributed Vibration Sensing (DVS)-OTDR device, may include any variant of an OTDR device capable of performing vibration measurement along optical fibers (e.g. by employing a laser source that is substantially coherent). For example, Rayleigh scatter-based DAS uses a Coherent OTDR (C-OTDR) where a coherent laser pulse is sent along the optical fiber. As similar measurement technique in conventional OTDRs, for the C-OTDR the interfered intensities of any two or more reflected coherent lights are measured as a function of time after transmission of the laser pulse. Any of these examples and equivalents thereto are considered to be within the scope of the definition of a DAS-OTDR.

It will however be understood that implementations of the present technology are not limited to DAS-OTDR implementations. In other implementations, the test signals sensitive to the vibration events may for example be embodied by an Optical Frequency Domain Reflectometry (OFDR) device, that operates by modulating the frequency of a laser source over time, creating a varying optical signal that is injected into the deployed optical fiber. As the modulated signal travels through the deployed optical fiber, some of the light may be backscattered or reflected due to vibration events affecting the deployed optical fiber. This backscattered light is then collected and made to interfere with a reference signal. By analyzing the resulting interference pattern, the OFDR device may determine the location and characteristics of the vibration events along the deployed optical fiber.

Referring still to FIG. 1, the interrogating unit 102 also sends a second test signal 162 sensitive to the vibration events in the second deployed optical fiber 111 and receives a second return test signal 164 therefrom. Similarly to the first deployed optical fiber 110, the interrogating unit 102 relies on DAS-OTDR to receive the second return test signal 164 and locate the vibration events affecting the second deployed optical fiber 111.

In the non-limiting implementation of FIG. 1, the interrogating unit 102 includes a second DAS-OTDR device 101B configured to send the second test signal 162 through the second deployed optical fiber 110 and to receive the second return test signal 164 therefrom. The second DAS-OTDR device 101B may be implemented in a same or a different manner than the first DAS-OTDR device 101A. Because the second DAS-OTDR device 101B also relies on reflectometry as the first DAS-OTDR device 101A to locate the vibration events affecting the second deployed optical fiber 111, for the sake of brevity, detailed descriptions of operations of the second DAS-OTDR device 101B will not be repeated unless necessary for the understanding of the implementation.

Referring still to FIG. 1, the system 100 includes a controller 200 communicably connected to the interrogating unit 102. The controller may be configured to perform analysis of the first and second return test signals 154 and 164. In the depicted non-limiting implementation of FIG. 1, the controller 200 is a single controller. In alternative non-limiting implementations of the present technology, the functionality of the controller 200 may be distributed and may be implemented via multiple controllers. For example, the functionality of the controller 200 relative to the first or second DAS-OTDR device 101A, 101B may be implemented in the corresponding DAS-OTDR device itself.

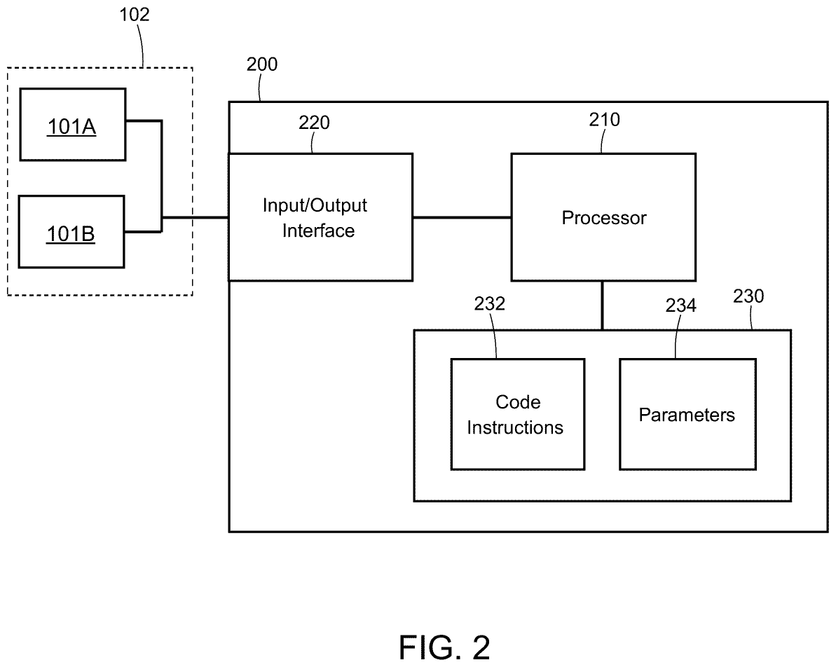

As an example, FIG. 2 is a schematic block diagram of the controller 200 of the interrogating unit 102 according to some implementations of the present technology. The controller 200 includes a processor or a plurality of cooperating processors (represented as a processor 210 for simplicity), a memory device or a plurality of memory devices (represented as a memory device 230 for simplicity), and an input/output interface 220 allowing the controller 200 to communicate with other components of the interrogating unit 102 and/or other components in remote communication with the interrogating unit 102. The processor 210 is operatively connected to the memory device 230 and to the input/output interface 220. The memory device 230 includes a storage for storing parameters 234. The memory device 230 may include a non-transitory computer-readable medium for storing code instructions 232 that are executable by the processor 210 to allow the controller 200 to perform the various tasks allocated to the controller 200 in the methods disclosed herein.

In this implementation, the controller 200 is operatively connected, via the input/output interface 220, to the first and second DAS-OTDR devices 101A, 101B. The controller 200 executes the code instructions 232 stored in the memory device 230 to implement the various above-described functions that may be present in a particular implementation. FIG. 2 as illustrated represents a non-limiting implementation in which the controller 200 orchestrates operations of the interrogating unit 102. This particular implementation is not meant to limit the present disclosure and is provided for illustration purposes.

Based on the first test signal 152 and the first return test signal 154, the interrogating unit 102 locates the vibration events affecting the first deployed optical fiber 110. Similarly, based on the second test signal 162 and the second return test signal 164, the interrogating unit 102 locates the vibration events affecting the second deployed optical fiber 111. In this implementation, the interrogating unit 102 relies on reflectometry to do so.

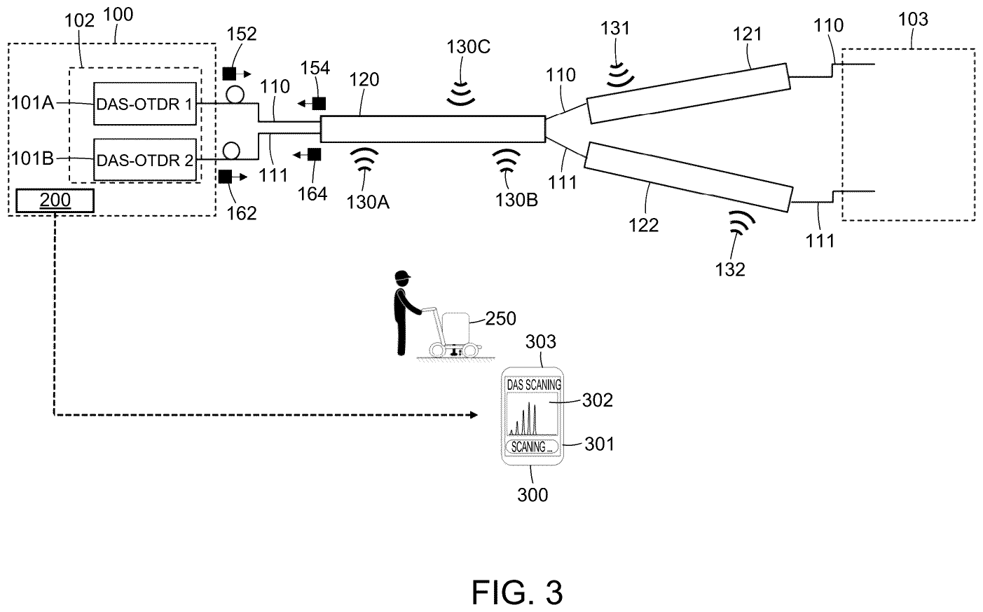

In some implementations, the system 100 may collaborate with a vibration generating unit 250, as depicted on FIG. 3, configured to artificially generate at least one of the vibration events on a ground surface located in a vicinity of at least one of the first and second deployed optical fibers 110, 111. In this implementation, the vibration generating unit 250 is mobile (e.g. includes wheels or tracks) and includes a hammer head configured to generate vibration events that may be repeatable (i.e. with a same pattern and intensity) on the ground surface above at least one of the first and second deployed optical fibers 110, 111. The vibration generating unit 250 may include a controller and a Global Positioning System (GPS) module. In some implementations, the vibration generating unit 250 is operated by a human operator. Once the vibration generating unit 250 is supposedly located above at least one of the first and second deployed optical fibers 110, 111, for example based on data provided by the GPS module, the controller may actuate the hammer head to strike the ground surface and generates a pulse of energy that travels as vibration through the ground, concurrently to sending the at least one test signal. When the hammer head impacts the ground surface, a shock wave radiates causing vibrations in the surrounding area and potentially in the at least one of the first and second deployed optical fibers 110, 111. This may be used in circumstances where intensities of current vibrations events are not high enough to be suitably detected by the interrogating unit 102.

In use, the operator may use an operator device 300 communicably connected to the controller 200. In some implementations, the operator device 300 may be implemented by any of a conventional personal computer, a controller, and/or an electronic device (e.g., a server, a controller unit, a control device, a monitoring device etc.) and/or any combination thereof appropriate to the relevant task at hand. The operator device 300 may be, for example and without being limitative, a cellphone, a laptop, a tablet, a handheld computer, a personal digital assistant, a media player, a navigation device or a combination of two or more of these data processing devices or other data processing devices. The operator device 300 may include various hardware components including one or more single or multi-core processors, a solid-state drive, a random access memory (RAM), a dedicated memory and an input/output interface. The input/output interface may provide networking capabilities such as wired or wireless access. As an example, the input/output interface may include a networking interface such as, but not limited to, one or more network ports, one or more network sockets, one or more network interface controllers and the like. Multiple examples of how the networking interface may be implemented will become apparent to the person skilled in the art of the present technology. As a person in the art of the present technology may appreciate, multiple variations as to how the operator device 300 is implemented may be envisioned without departing from the scope of the present technology.

Further, the operator device 300 may include a display 303 or screen capable of rendering images, including graphical plots, Graphical User Interfaces (GUIs), program output, etc. In some implementations, the display 303 includes and/or is housed with a touchscreen to permit the human operator to input data via some combination of virtual keyboards, icons, menus, or other Graphical User Interfaces (GUIs).

In this implementation, the operator device 300 is communicably connected to the controller 200 of the system 100 over a communication network via any wired or wireless communication link including, for example, 4G, LTE, Wi-Fi, or any other suitable connection, and receives indication of the amplitudes of the return test signals therefrom. For example, the communication network can be implemented differently, such as any wide-area communication network, local-area communication network, a private communication network and the like. How the communication links between the controller 200 and the operator device 300 are implemented will depend inter alia on how the controller 200 and the operator device 300 are implemented. In some implementations, at least some of the functionalities of the controller 200 of the system 100 are controllable by a controller of the operator device 300. For example, the human operator may cause the emission of the at least one test signal by the interrogating unit 102 upon clicking a scanning button 301 on the display 303, concurrently to the artificial generation of at least one of the vibration events by the vibration generating unit 250. Once the return test signal has been received and analysed by the interrogating unit 102, the controller 200 may transmit information about the amplitudes of the return test signals to the operator device 300 for display to the human operator 210. In other words, the operator device 300 may receive, upon the vibration events being generated by the vibration generating unit 250, indications of current amplitudes of the return test signal from the controller 200. Therefore, the operator device 300 may indicate to the operator when the vibration event is detected by the interrogating unit 102 by receiving the at least one return signal from the first and second deployed optical fibers 110, 111.

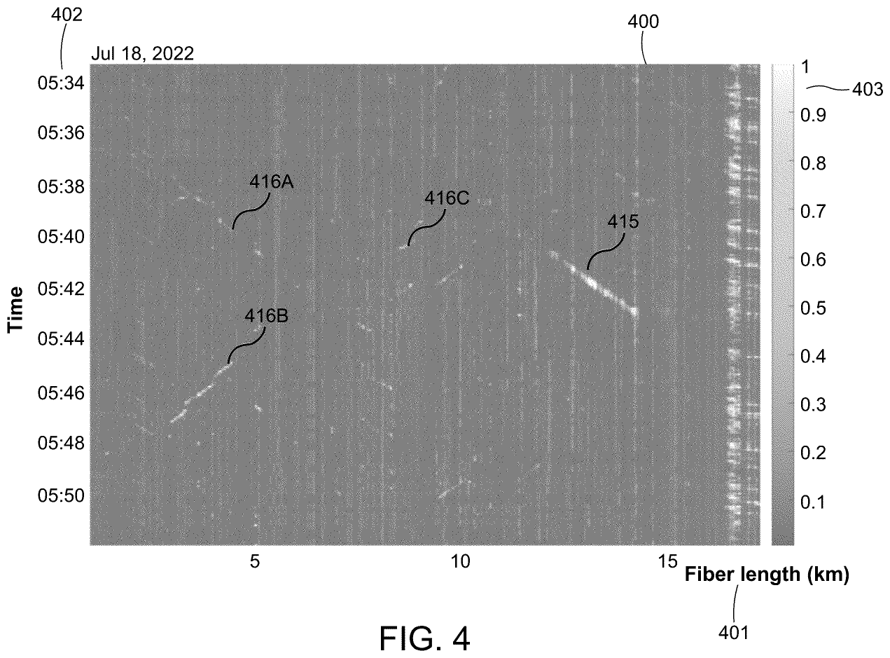

Referring back to the illustrative implementation of FIG. 1 and with additional reference to FIG. 4, the controller 200 may generate a DAS signal concatenation plot 400 based on the first or second return test signal 154, 164, which can also be referred to as a “waterfall plot 400”, representative of a measured vibration intensity as a function of time and of a distance along the first or the second deployed optical fibers 110,11 respectively, as depicted on FIG. 4. The waterfall plot 400 represents concatenated DAS signals captured by the first or second DAS-OTDR device 101A, 101B during a pre-determined amount of time and thus represents vibration events through distance and time.

As depicted on FIG. 4, the waterfall plot 400 includes a distance axis 401, a time axis 402 and an intensity scale 403 and displays vibration intensity of the vibration events having affected the first deployed optical fiber 110 as a function of the distance there along and time. In this particular example, the waterfall plot 400 includes a signature 415 of a vibration event caused by a train in a vicinity of the 13^{th} kilometer of the first deployed optical fiber 110 at about 5:42, and signatures 416A, 416B and 416C of corresponding vibration events caused by cars in a vicinity of the 3^{rd} and 10^{th} kilometers of the first deployed optical fiber 110. The vibration events affecting the first deployed optical fiber 110 may thus be located based on reflectometry.

In this implementation, the first and second test signals 152, 162 are sent in a simultaneous manner by the interrogating unit 102 such that vibration events affecting the first and second deployed optical fibers 110, 111 may be simultaneously identified and located. A given vibration event affecting the first and second deployed optical fibers 110, 111 in the communication cable 120, such as the vibration event 130C, may thus simultaneously affect both of the first and second return test signals 154, 164, and will show on the corresponding waterfall plot.

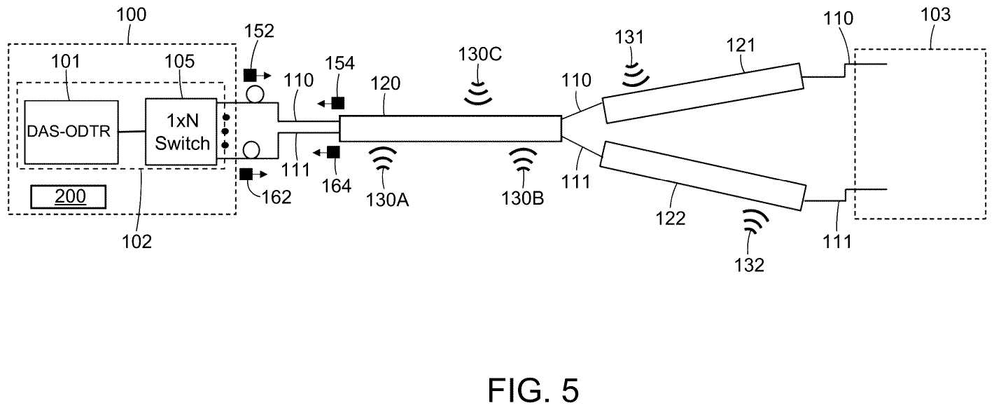

In alternative implementations and with reference to FIG. 5, the interrogating unit 102 may include a main DAS-OTDR device 101, instead of two distinct DAS-OTDR devices, configured to perform the emission of the at least one test signal and the reception of corresponding at least one return test signals. In this variant, the interrogating unit 102 includes a switching module 105 communicably connected to the main DAS-OTDR device 101 and a subset of deployed optical fibers of the communication network, a number of optical fibers included in said subset being referred to as N. The subset may for example include the first and second deployed optical fibers 110, 111.

The switching module 105 is configured to selectively distribute test signals emitted by the main DAS-OTDR device 101 to the deployed optical fibers connected thereto, and to redirect return test signals from the deployed optical fibers to the main DAS-OTDR device 101. In this example, the switching module 105 is a 1×N switch. In this implementation, the test signals such as the first and second test signals 152, 162 may be sent in a consecutive manner by the main DAS-OTDR device 101.

For example, the main DAS-OTDR device 101 may first emit the first test signal 152 to the switching module 105 that directs the first test signal 152 to the first deployed optical fiber 110. The main DAS-OTDR device 101 may subsequently emit the second test signal 162 to the switching module 105 that directs the second test signal 162 to the second deployed optical fiber 111. In this implementation, the first and second test signals 152, 162 are emitted in a quasi-simultaneous manner, which causes the first and second return test signals 154, 164 to be acquired by the interrogating unit 102 in a quasi-simultaneous manner. Identification and location of common optical path portions may still be performed by the interrogating unit 102. Indeed, vibration events are not high-speed events. These vibration events typically last long enough to be captured by both acquisition if the switching of the switching module 105 and acquisition time of the interrogating unit 102 are faster that a duration of the vibration events.

As an example, the main vibration source in cities and suburb areas are automobile circulation and railways. Considering a vehicle moving at a speed of 100 km/h, it would have moved of 28 meters in 1 second. Thus, in response to each DAS acquisition being generated in 0.5 second, a 14 m difference between successive measurements may be experienced on average. This difference is small enough to perform path diversity processing on deployed optical fibers that typically have a length of a few kilometers.

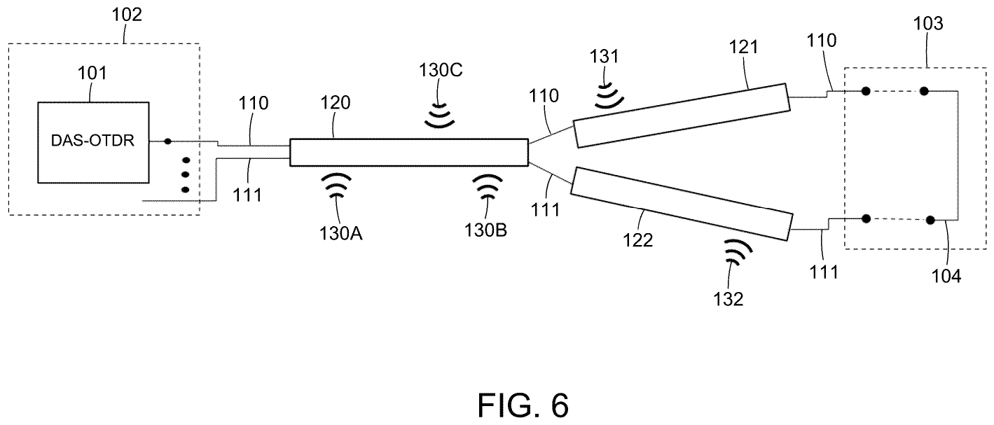

In yet other alternative implementations and with reference to FIG. 6, the first and second deployed optical fibers 110, 111 may form a loopback configuration to increase time-efficiency of the identification of the one or more common optical path portions. In this configuration, the first and second deployed optical fibers each have a proximal end and a distal end, the distal ends being optically connected together at the landing site 103 through an optical connection 104.

In the implementation of FIG. 6, both of the first and second deployed optical fibers 110, 111 are tested using a same test signal. The step of sending at least one test signal in the first and second deployed optical fibers 110, 111 includes sending a single test signal employing the main DAS-OTDR device 101, the single test signal propagating successively in the first and second deployed optical fibers 110, 111.

A single return signal is thus received by the main DAS-OTDR device 101 from the first and second deployed optical fibers 110, 111. The loop back configuration may be suited for relatively short optical fibers that fit within twice the dynamic range of the interrogating unit 102, where an access to the landing site 103 is provided.

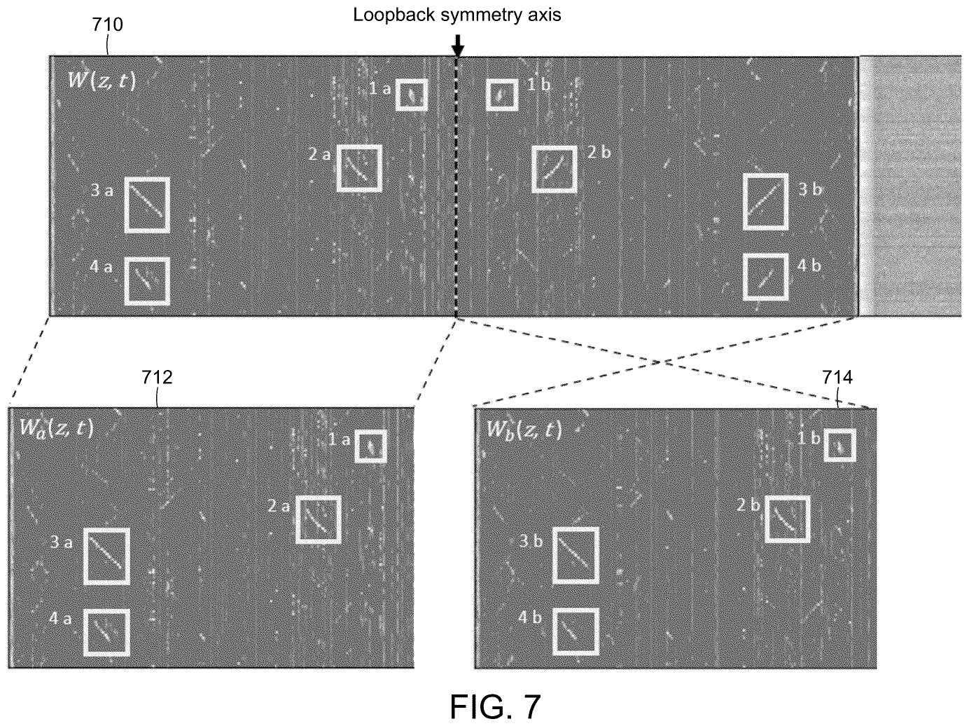

Upon receiving the single return test signal, the controller 200 is configured to build a global waterfall plot representing a measured vibration intensity as a function of time and of distance along the first and second deployed optical fibers, based on the single return test signal. FIG. 7 shows a global waterfall plot 710. The controller further splits the global waterfall plot 710 into first and second waterfall plots 712, 714 associated with the first and the second deployed optical fibers, respectively, based on a position of the optical connection 104 relatively to a length of the first and second deployed optical fibers 110, 111. In this example, the second waterfall plots 714 is inverted as the single test signal was sent successively in the first and second deployed optical fibers 110, 111. A few vibration events are also highlighted as examples on FIG. 7.

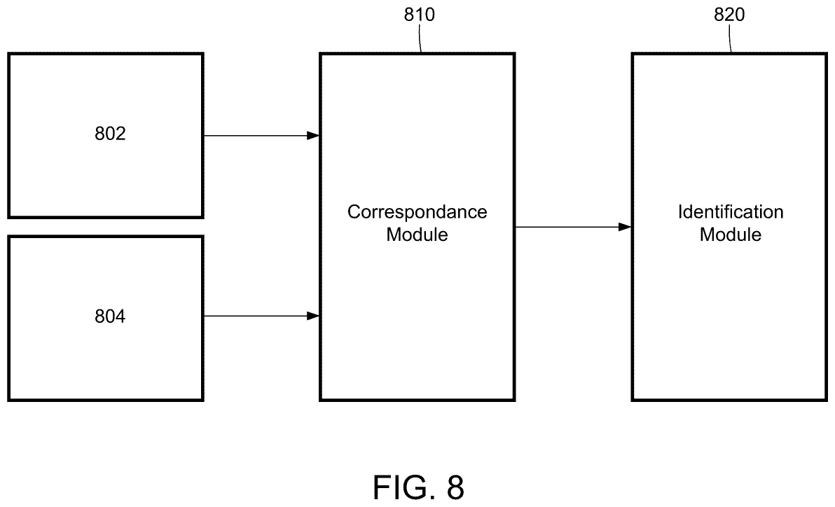

With reference to FIG. 8, the controller 200 further executes a correspondence module 810 that receives waterfall plots 802, 804 obtained from the at least one return test signal, as inputs. The waterfall plots 802, 804 may for example correspond to the waterfall plots 712, 714 respectively. As another example, the waterfall plots 802, 804 may respectively correspond to waterfall plots generated from the first and second return test signals 154, 164 in the implementation of FIG. 1. It should be noted that the correspondence module 510 may receive a higher number of waterfall plots in alternative implementations where a higher number of deployed optical fibers in the communication network are involved. In use, the correspondence module 810 determines a correspondence between the vibration events located along the first and the second deployed optical fibers 110, 111 respectively. In the context of the present disclosure, a correspondence between two given vibration events may be understood as a correspondence of a time and duration of the occurrence of the vibration events and an intensity and/or a pattern of the intensity of the vibration events along that duration.

In some implementations, the controller 200 may apply a denoising filter to the waterfall plots, or any other pre-processing operations, before executing the correspondence module 510.

In some implementations, the controller 200 executes the correspondence module 510 in response to a number of vibration events identified in each of the waterfall plots 802, 804 being above a pre-determined number threshold. In other words, the controller 200 may proceed to the determination of a correspondence between the vibration events located along the first and the second deployed optical fibers 110, 111 in response to the corresponding waterfall plots including enough vibration events to be analyzed. In some implementations, the number of successive acquisitions is stopped once the number of vibration events identified in the first and second deployed optical fibers 110, 111 is above the number threshold.

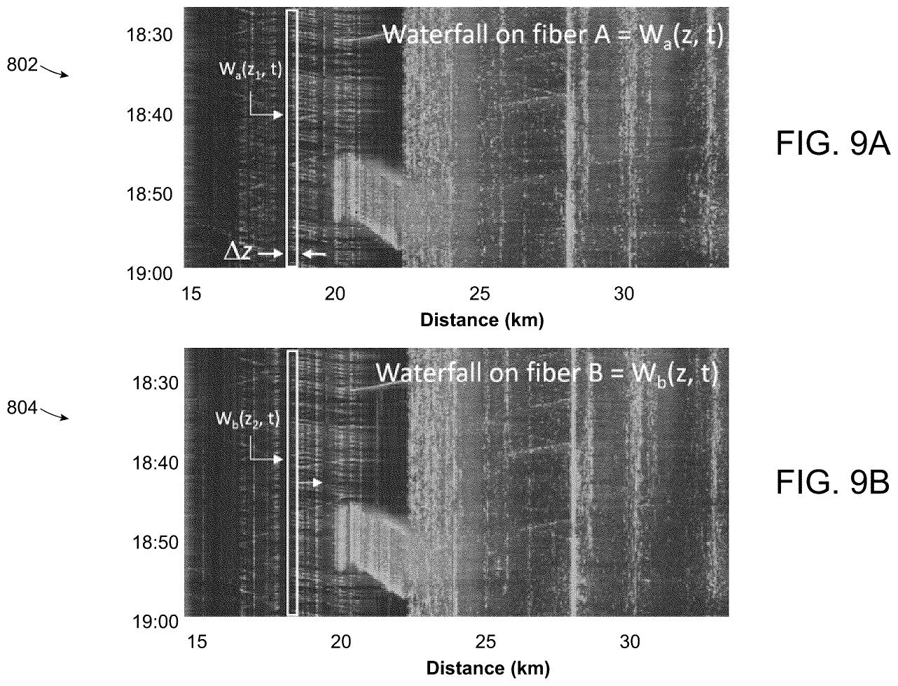

In some implementations, execution of the correspondence module 810 may cause the controller 200 to perform a cross-correlation of the waterfall plots 802, 804. More specifically, FIGS. 9A and 9B respectively show the waterfall plots 802, 804 where z stands for the distance along the first and second deployed optical fibers 110, 111 respectively, and t stands for time. In this example, a correlation value is computed over time, on a slice of range Δz:

$$Correlation ( {z}_{1} , {z}_{2} ) = \frac{{\sum }_{t} {W}_{a} ( {z}_{1} , t ) * {W}_{b} ( {z}_{2} , t )}{\sqrt{{\sum }_{t} {{W}_{a} ( {z}_{1} , t )}^{2}} \cdot \sqrt{{\sum }_{t} {{W}_{b} ( {z}_{2} , t )}^{2}}}$$

where Wₐ is the waterfall plot 802 and W_{b} is the waterfall plot 804.

In some implementations, the controller 200 may perform the cross-correlation in an iterative manner. More specifically, the controller 200 selects a first span of the waterfall plot 802 and further parses through the waterfall plot 804. The controller 200 may identify a second span of the waterfall plot 804 for which a correlation between the first and second spans is found (e.g. a correlation value between the first and second spans is above a given threshold). The controller 200 then incrementally adjusts the first and second spans on the waterfall plots 802, 804 respectively and further assesses the correlation between the adjusted spans. The controller 200 may iteratively adjust the spans until an entirety of the waterfall plots 802, 804 have been analyzed.

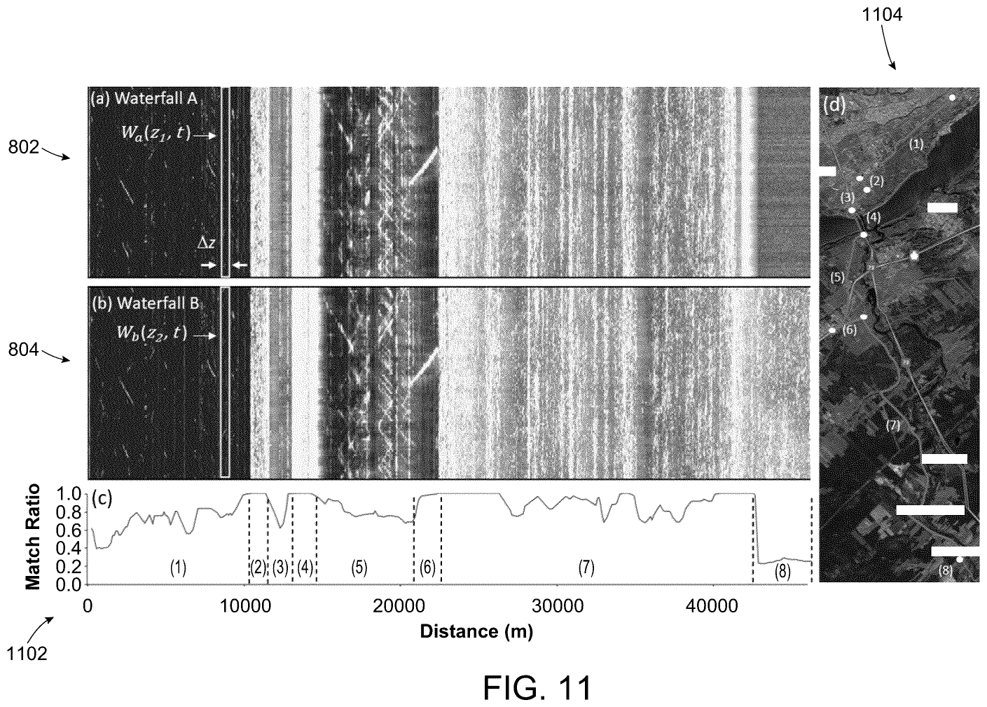

An illustrative correlation analysis between the first and second deployed optical fibers 110, 111 is shown on FIG. 11. A map 1104 represents eight optical path portions of a communication network. Section (1) corresponds to an urban road in downtown area of Quebec City, Canada, where diagonal lines indicate vehicle traffic. Some parts of this section (1) are blind to vibration signals. However, neighboring signatures can provide clues about communication cable continuity. Section (2) is an aerial fiber segment. Section (3) continues through an urban path. Section (4) spans a bridge that crosses the St. Lawrence River in Quebec City. Section (5) is a highway where displays denser traffic vibration signatures. Section (6) is the fiber section that follows a railway. Section (7) depicts a recording during very windy conditions. Section (8) marks the point where the two fibers stop sharing the same communication cable. In this illustrative example, the first and second deployed optical fibers 110, 111 belong to a same communication cable from section (1) to section (7), and have different optical portions along section (8). It should be noted that, when vibration signals are saturated for the aerial fiber sections, such as section (2), it may be challenging to determine if the deployed optical fibers share the same optical path portion. However, this problem can still be resolved to use longer measurement time especially to acquire data during calm wind conditions.

In this example, the two waterfall plots 802, 804 have respectively been acquired from the first and second deployed fibers 110, 111, where acquisitions have been recorded for a time period of over three minutes for fiber lengths of about 45 kilometers. The match ratio is computed over a time duration, as an example for data acquisition time of 3 minutes, on a slice of fiber length range. A simple binary matching function determines if and where a slice at a position z1 of the first waterfall plot 802 matches with a slice of a same range at a position z2 of the second waterfall plot 804. For example, the number of vibration events at the closed neighbor times and at the same positions on the first and second waterfall plots 802, 804 may be counted and divided by the total number of vibrations from both waterfall plots to determine a given correlation value for said same positions. Graph 1102 shows the correlation values determined based on a cross-correlation of the first and second waterfall plots 802, 804, showing relatively low correlation values for section (8).

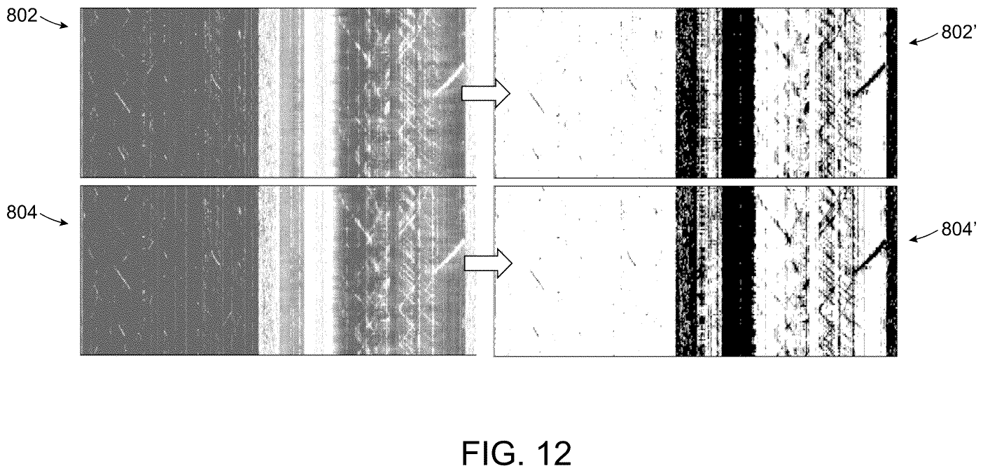

In some implementations, the controller 200 is configured to binarize the first and second waterfall plots 802, 804 using a pre-determined intensity threshold, as illustrated on FIG. 12, thereby obtaining binarized waterfall plots 802′, 804′ respectively. In these implementations, the controller 200 proceeds with the comparison of the binarized waterfall plots 802′, 804′ by identifying and counting the number of vibration events on a slice of range Δz, at substantially same times and at the same positions on the binarized waterfall plots 802′, 804′. The controller 200 further divides this number of vibration events by the total sum of vibrations events from both binarized waterfall plots 802′, 804′. The controller 200 may further identify the slice of range Δz as part of a common optical path portion in response to the divided value being above a pre-determined threshold.

The controller 200 further identifies the one or more common optical path portions between the first and second optical fibers 110, 111 based on the correspondence between the vibration events identified at the first and second deployed optical fibers 110, 111. In this implementation and as depicted on FIG. 5, the controller 200 executes an identification module 520 to do so.

The identification module 520 may identify a common optical path portion based on correlation values determined by the correspondence module 510. FIG. 7 illustrates correlation values obtained by execution of the correspondence module 510 for a first and a second illustrative waterfall plots. It can be seen that the correlation between the two illustrative waterfall plots is above a correlation threshold for a given span identified as a “shared section”. Ranges in between which the shared section extends are indicative of a location of a common optical path portion between a given first and a given second deployed optical fibers 110, 111 corresponding to the first and second illustrative waterfall plots. In this example, the shared section ca be seen to correspond to the communication cable 120 shown in FIG. 1.

It should be noted that the cross-correlation operation is a mere example of an operation to determine the correspondence between the vibration events located along the first and the second deployed optical fibers 110, 111. Other metric or distance-based mathematical operations suitable for determining the difference or distance between data of waterfall plots may be contemplated in alternative implementations. It can be said that determining a correspondence between the vibration events affecting the first and second deployed optical fibers 110, 111 includes determining an overlap between the vibration events located in the first and second deployed optical fibers.

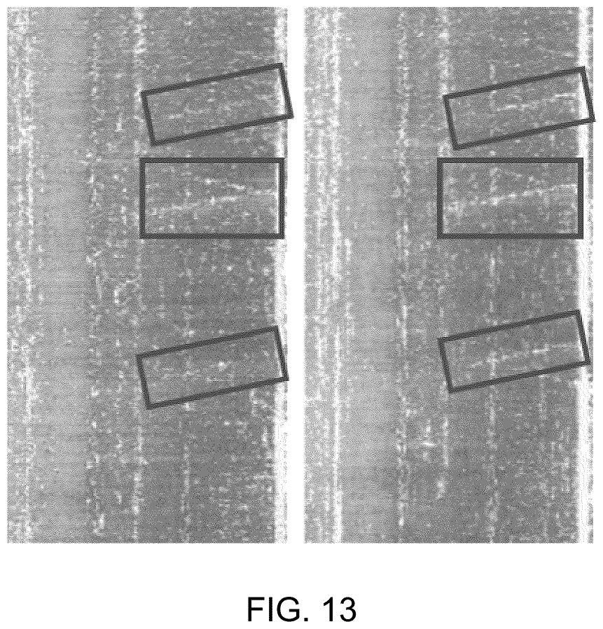

In some implementations, more complex algorithms may be additionally used to identify patterns in noisy environment or “weak patterns”. The controller 200 may, upon execution of the correspondence module 810, execute a machine learning model (MLM) such as Convolutional Neural Networks (CNNs) based model that offers a robust solution due to their hierarchical feature extraction capabilities. By training on a dataset of noisy and clean images, a pre-trained MLM may be able to identify and enhance weak signals, as depicted in boxes in FIG. 13, while suppressing noise. The MLM used by the controller 200 may include data augmentation and dropout techniques to improve robustness and prevent overfitting.

In some implementations, the present technology may be used to determine, for any portion of the communication network between two or more points, a path diversity score. The path diversity score may be based on the identified common optical path portions thereof and is indicative of a diversity of a route of the given deployed optical fiber relatively to other deployed optical fibers of the communication network.

Once the common optical path portions between the first and second deployed optical fibers 110, 111 are identified, the controller may determine a path diversity score for any of those optical fibers. In the context of the present disclosure, a path diversity score between two deployed optical fiber may be defined as:

$$D = 100 * ( {L}_{f} - {S}_{f} ) / {L}_{f}$$

where L_{f} is a total length of the given deployed optical fiber, and S_{f} is a total length of the given deployed optical fiber that is part of a common optical path portion with any other deployed optical fiber of the communication network.

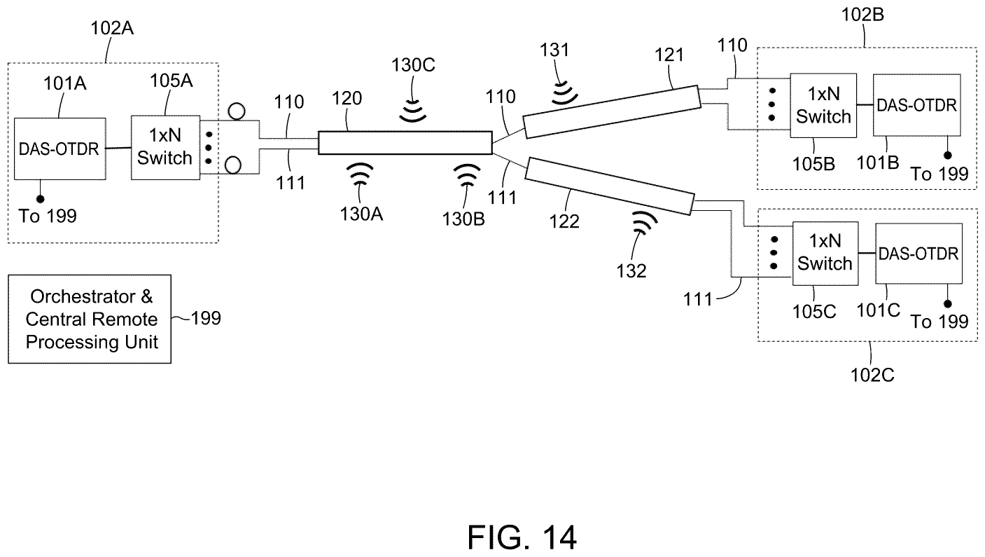

FIG. 14 illustrates a configuration of the communication network including a plurality of interrogating unit 102A, 102B and 102C, wherein both end of each deployed optical fiber is communicably connected to one of the interrogating units 102A, 102B and 102C. The depicted number of interrogating units is not limitative. A different number of interrogating units may be contemplated in alternative implementations.

In this implementation, the interrogating units 102A, 102B and 102C are synchronized to acquire data in a quasi-simultaneous manner. Developers of the present technology have established that 1-second synchronization is typically sufficient to capture quasi-simultaneous events, basic computer clock synchronization is adequate to meet this 1-second quasi-simultaneous sampling condition, the interrogating units 102A, 102B and 102C are communicably connected to a central processing unit 199 (e.g. a controller). The central processing unit 199 orchestrates the operations of the interrogating units 102A, 102B and 102C, causing each of them to perform successive acquisitions as previously described. The recorded waterfall plots from each interrogating unit 102A, 102B and 102C are transferred to the central processing unit 199, which processes all the data using the method described herein.

In use, two or more interrogating units may be connected to fibers at the same end of a cable, causing the test signals emitted by the two or more interrogating units to travel in the same direction, also referred to as the “copropagating” configuration. This is illustrated by interrogating units 101B and 101C for deployed optical fibers in the communication cable 120 in FIG. 14. In this scenario, the processing is the same as previously described. In the “counterpropagating” configuration, two or more interrogators are connected to the same deployed optical fibers at opposite ends of a communication cable, causing the test signals to travel in opposite directions. This is illustrated by interrogating units 101A and 101B, and 101A vs. 101C for deployed optical fibers in cable 120 in FIG. 14. In this scenario one of the waterfall plots is inverted before the cross-correlation may be executed. Using these techniques and the network of interrogating units allows for the automatic identification of all common optical path portions shared by the deployed optical fibers in a communication network, providing comprehensive documentation for all deployed optical fibers connected to the interrogating units.

The determination of the one or more common optical path portions and the path diversity score may be used in different cases. For example, when an operator acquires an existing optical network that is not correctly documented, several issues can arise, particularly with “lost” fibers. Without proper documentation, it may become challenging to identify which fibers are active, which are spare, and which might be damaged or unused. This can lead to significant delays in network deployment and troubleshooting. An application of the network interrogating units depicted on FIG. 14 is to identify the path of a deployed optical fiber with an unknown route by leveraging and comparing it to deployed optical fibers in communication cables where the path is known. Using the same principles described here, it is possible to discover where a given communication cable is installed by comparing the vibration waterfall plots of the “lost fiber” to other deployed optical fibers. Given that some deployed optical fibers and communication cables are properly documented, using a network of interrogating units as illustrated on FIG. 14 may provide comprehensive documentation for all deployed optical fibers connected to the interrogating units. This documentation will then allow operators to associate lost fibers with a path on the cables of the network.

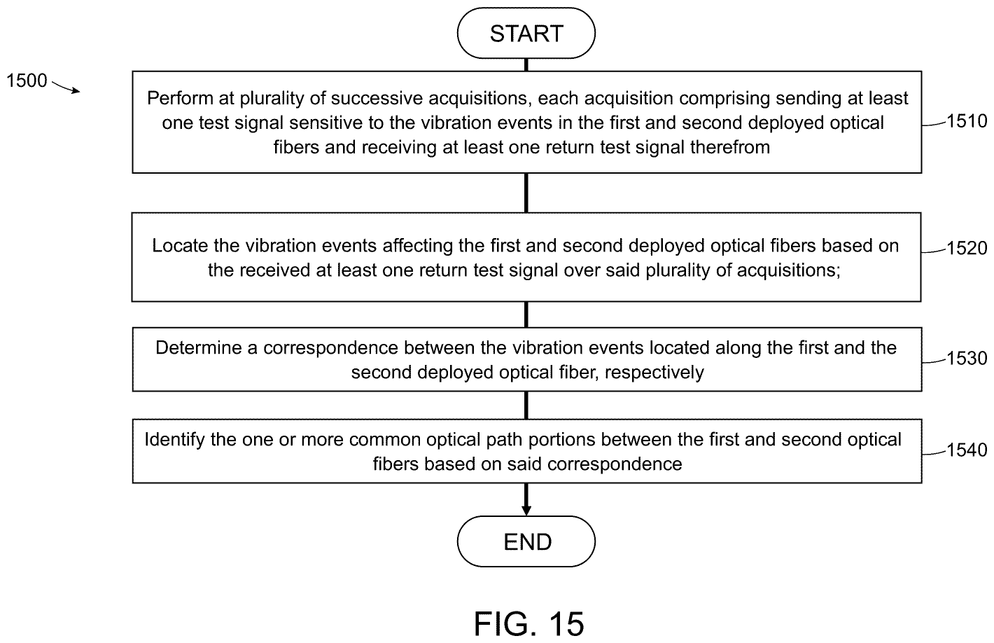

FIG. 15 is a flow diagram of a method 1500 for identifying one or more common optical path portions between a first and a second deployed optical fibers of a communication network, each of the first and second deployed optical fibers being potentially affected by vibration events therealong, according to some implementations of the present technology. In one or more aspects, the method 1500 or one or more steps thereof may be performed by a controller or a computer system, such as the controller 200. The method 1500 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1500 starts with performing, at operation 1510, a plurality of successive acquisitions, each acquisition comprising sending at least one test signal sensitive to the vibration events in the first and second deployed optical fibers and receiving at least one return test signal therefrom.

In some implementations, sending the at least one test signal and receiving the at least one return signal includes employing at least one Distributed Acoustic Sensing (DAS)-optical time-domain reflectometer (OTDR). For example, a first test signal may be sent in the first deployed optical fiber, and a first return test signal may be received therefrom. In this example, a second test signal may be sent in the first deployed optical fiber and a second return test signal therefrom. The at least one DAS-OTDR may include a first and a second DAS-OTDR, such that the first DAS-OTDR sends the first test signal and receives the first return test signal, and the second DAS-OTDR sends the second test signal and receives the second return test signal, the first and second test signals being sent in a simultaneous manner. As another example, the at least one DAS-OTDR may include a main DAS-OTDR configured to send both the first and the second test signals and to receive both the corresponding first and second return test signals, the first and second test signals being sent in a consecutive manner.

In some implementations, the method 1500 includes artificially generating, by a vibration generator unit, at least one of the vibration events on a ground surface located in a vicinity of at least one of the first and second deployed optical fibers concurrently to sending the at least one test signal.

The method 1500 continues with locating, at operation 1520, the vibration events affecting the first and second deployed optical fibers based on the received at least one return test signal over said plurality of acquisitions.

In some implementations, the vibration events affecting the first deployed optical fiber may be located by comparing respective phases of the first test signal and the first return test signal. In alternative implementations, the vibration events affecting the first deployed optical fiber may be located by comparing respective intensities of the first test signal and the first return test signal.

The method 1500 continues with determining, at operation 1530, a correspondence between the vibration events located along the first and the second deployed optical fiber, respectively.

In some implementations, determining a correspondence includes determining an overlap between the vibration events located in the first and second deployed optical fibers. The determination of the correspondence between the vibration events may be executed in response to a number of the first vibration events and a number of second vibration events being above respective number thresholds.

In some implementations, the method 1500 further includes, prior to determining the correlation values, binarizing the first and second waterfall plots using a pre-determined intensity threshold, determining correlation values including determining correlation values between the first and second binarized waterfall plots. In addition or alternatively, a pre-trained machine learning model (MLM) may be employed to identify and denoise weak signals in the first and second waterfall plots.

In some implementations, the correspondence between the vibration events located along the first and the second deployed optical fibers is determined by building first and second waterfall plots representing a measured vibration intensity as a function of time and of a distance along the first and the second deployed optical fibers, based on the first and second return test signal, respectively. The first and second waterfall plots are further compared to determine the correspondence. For example, the first and second waterfall plots may be compared by determining correlation values between the first and second waterfall plots at corresponding distance values, the correspondence being based on said correlation values.

In some alternative implementations, the at least one DAS-OTDR includes a main DAS-OTDR and the first and second deployed optical fibers each have a proximal end and a distal end, the distal ends being optically connected together. In these implementations, a single test signal is sent, and a single return test signal is received by employing the main DAS-OTDR connected to the proximal end of the first deployed optical fiber, the single test signal propagating successively in the first and second deployed optical fibers.

In these implementations, the correspondence between the vibration events located along the first and the second deployed optical fibers is determined by building a global waterfall plot representing a measured vibration intensity as a function of time and of distance along the first and second deployed optical fibers, based on the single return test signal. The global waterfall plot is further split into first and second waterfall plots associated with the first and the second deployed optical fibers, respectively, and the second waterfall plot is inverted to be further compared with the first waterfall plot.

The method 1500 continues with identifying, at operation 1540, the one or more common optical path portions between the first and second optical fibers based on said correspondence.

In some implementations, identifying the one or more common optical path portions includes determining a length of the one or more common optical path portions, and locating the one or more common optical path portions along the first deployed optical fiber.

In the same or other implementations, the method 1500 further includes determining a path diversity score for the first deployed optical fiber based on a length of the one or more common optical path portions, and a total length of the first deployed optical fiber.

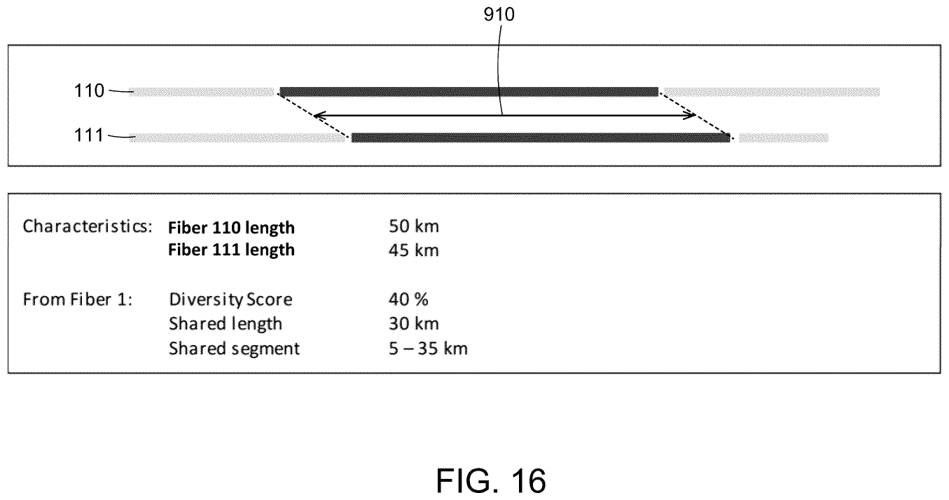

FIG. 16 is a visual representation of the first and second deployed optical fibers 110, 111. In this illustrative example, the first deployed optical fiber 110 has a length of 50 kilometers, the second deployed optical fiber 111 has a length of 45 kilometers. As depicted, the first and second deployed optical fibers 110, 111 have a common optical path portion 910 of 30 kilometers. In this illustrative example and assuming that no other optical fiber has a common optical path portion shared with the first deployed optical fiber 110, the first deployed optical fiber 110 has a diversity score of:

$${D}_{1} = 100 * ( {L}_{f} - {S}_{f} ) / {L}_{f} = 100 * ( 50 - 30 ) / 50 = 40 \% .$$

As described herein before, the correspondence between the vibration events that led to the identification of the common optical path portion 910 is a correspondence of a timing and intensity of the vibration events, rather than a correspondence of a relative location thereof along the first and second deployed optical fibers 110, 111 respectively.

It will be appreciated that at least some of the operations of the method 1500 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which includes storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described implementations but should be defined only in accordance with the following claims and their equivalents.

1. A method for identifying one or more common optical path portions between a first and a second deployed optical fibers of a communication network, each of the first and second deployed optical fibers being potentially affected by vibration events therealong, the method comprising:
performing a plurality of successive acquisitions, each acquisition comprising sending at least one test signal sensitive to the vibration events in the first and second deployed optical fibers and receiving at least one return test signal therefrom;
locating the vibration events affecting the first and second deployed optical fibers based on the received at least one return test signal over said plurality of acquisitions;
determining a correspondence between the vibration events located along the first and the second deployed optical fiber, respectively; and
identifying the one or more common optical path portions between the first and second optical fibers based on said correspondence.

2. The method according to claim 1, wherein sending the at least one test signal and receiving the at least one return signal comprises employing at least one Distributed Acoustic Sensing-optical time-domain reflectometer (DAS-OTDR).

3. The method according to claim 2, wherein sending at least one test signal in the first and second deployed optical fibers and receiving at least one return test signal comprises:
sending a first test signal in the first deployed optical fiber and receiving a first return test signal therefrom; and
sending a second test signal in the second deployed optical fiber and receiving a second return test signal therefrom.

4. The method according to claim 3, wherein the at least one DAS-OTDR comprises a first and a second DAS-OTDR, and wherein:
sending the first test signal and receiving the first return test signal comprises employing the first DAS-OTDR; and
sending the second test signal and receiving the second return test signal comprises employing the second DAS-OTDR,
wherein the first and second test signals are sent in a simultaneous manner.

5. The method according to claim 3, wherein the at least one DAS-OTDR comprises a main DAS-OTDR, and sending the first and the second test signals and receiving the corresponding first and second return test signals comprises employing the main DAS-OTDR, wherein the first and second test signals are sent in a consecutive manner.

6. The method according to claim 1, wherein determining a correspondence between the vibration events located along the first and the second deployed optical fibers comprises determining an overlap between the vibration events located in the first and second deployed optical fibers.

7. The method according to claim 3, wherein determining a correspondence between the vibration events located along the first and the second deployed optical fibers comprises:
building first and second waterfall plots representing a measured vibration intensity as a function of time and of a distance along the first and the second deployed optical fibers, based on the first and second return test signal, respectively; and
comparing the first and second waterfall plots.

8. The method according to claim 7, wherein comparing the first and second waterfall plots comprises determining correlation values between the first and second waterfall plots at corresponding distance values, the correspondence being based on said correlation values.

9. The method according to claim 7, wherein comparing the comparing the first and second waterfall plots comprises:
binarizing the first and second waterfall plots using a pre-determined intensity threshold; and
for each slice of a plurality of distance slices of range Δz along the binarized first and second waterfall plots:
identifying and counting a number of said vibration events appearing at substantially same times and at same positions on the binarized first and second waterfall plots; and
dividing the number of said vibration events by a total sum said of vibrations events from both of the first and second binarized waterfall plots.

10. The method according to claim 7, further comprising employing a pre-trained machine learning model (MLM) configured to identify and denoise weak signals in the first and second waterfall plots.

11. The method according to claim 2, wherein the at least one DAS-OTDR comprises a main DAS-OTDR and the first and second deployed optical fibers each have a proximal end and a distal end, the distal ends being optically connected together; and
wherein sending at least one test signal in the first and second deployed optical fibers and receiving at least one return test signal comprises sending a single test signal and receiving a single return test signal employing the main DAS-OTDR connected to the proximal end of the first deployed optical fiber, the single test signal propagating successively in the first and second deployed optical fibers.

12. The method according to claim 11, wherein determining a correspondence between the vibration events located along the first and the second deployed optical fibers comprises:
building a global waterfall plot representing a measured vibration intensity as a function of time and distance along the first and second deployed optical fibers, based on the single return test signal;
splitting the global waterfall plot into first and second waterfall plots associated with the first and the second deployed optical fibers, respectively;
inverting the second waterfall plot; and
comparing the first and second waterfall plots.

13. The method according to claim 1, wherein determining a correspondence between the vibration events is executed in response to locating a number of said vibration events in the first and second deployed optical fibers above respective number thresholds.

14. The method according to claim 1, further comprising, concurrently to sending the at least one test signal, artificially generating, by a vibration generating unit, at least one of the vibration events on a ground surface located in a vicinity of at least one of the first and second deployed optical fibers.

15. The method according to claim 1, further comprising:
determining a path diversity score for the first deployed optical fiber based on:
a length of the one or more common optical path portions, and
a total length of the first deployed optical fiber.

16. A method for determining a path diversity score of a communication network, the communication network comprising a plurality of deployed optical fibers potentially affected by vibration events therealong, the method comprising, for each deployed optical fiber of a given subset of said plurality of deployed optical fibers:
performing at plurality of successive acquisitions, each acquisition comprising sending at least one test signal sensitive to the vibration events in the deployed optical fibers of the given subset and receiving at least one return test signal therefrom;
locating the vibration events affecting the deployed optical fibers of the given subset based on the received at least one return test signal over said plurality of acquisitions;
determining a correspondence between the vibration events located along the deployed optical fibers of the given subset;
identifying the one or more common optical path portions between deployed optical fibers of the given subset based on said correlation; and
determining a path diversity score for said subset of deployed optical fibers based on:
a length of the one or more common optical path portions, and
total lengths of the deployed optical fibers of the given subset.

17. A system for identifying one or more common optical path portions between a first and a second deployed optical fibers of a communication network, each of the first and second deployed optical fibers being potentially affected by vibration events therealong, the system comprising:
an interrogating unit communicably connected to the first and second deployed optical fibers and configured to perform a plurality of successive acquisitions, each acquisition comprising sending at least one test signal sensitive to the vibration events in the first and second deployed optical fibers and receiving at least one return test signal therefrom; and
a controller communicably connected to the interrogating unit and configured to:
locate the vibration events affecting the first and second deployed optical fiber based on the received at least one return test signal over said plurality of acquisitions,
determine a correspondence between the vibration events located along the first and the second deployed optical fiber, respectively; and
identify the one or more common optical path portions between the first and second optical fibers based on said correspondence.

18. The system according to claim 17, wherein the interrogating unit comprises at least one Distributed Acoustic Sensing-optical time-domain reflectometer (DAS-OTDR).

19. The system according to claim 18, wherein the at least one DAS-OTDR comprises a first and a second DAS-OTDR, and wherein:
the first DAS-OTDR is configured to send a first test signal in the first deployed optical fiber and receive a first return test signal therefrom; and
the second DAS-OTDR is configured to send a second test signal in the second deployed optical fiber and receive a second return test signal therefrom,
the controller controlling the first and second DAS-OTDR to send the first and second test signals in a simultaneous manner.

20. The system according to claim 18, wherein the at least one DAS-OTDR comprises a main DAS-OTDR configured to sent, in a consecutive manner, a first and a second test signals in the first and second deployed optical fibers, respectively, and receive therefrom corresponding first and second return test signals.

21. The system according to claim 18, wherein the controller is configured so that determining a correspondence between the vibration events located along the first and the second deployed optical fibers comprises:
building first and second waterfall plots representing a measured vibration intensity as a function of time and of a distance along the first and the second deployed optical fibers, based on the first and second return test signal, respectively; and
comparing the first and second waterfall plots.

22. The system according to claim 17, wherein determining a correspondence between the vibration events is executed in response to a number of the first vibration events and a number of second vibration events being above respective number thresholds.

23. The system according to claim 17, wherein the controller is further configured to determine a path diversity score for the first deployed optical fiber based on:
a length of the one or more common optical path portions, and
a total length of the first deployed optical fiber.
